(19) United States
(12) Patent Application Publication
(10) Pub. No.: US 2004/0034137 A1
(43) Pub. Date: Feb. 19, 2004

(54) Oligomer inhibitor for polyester fiber

(76) Inventors: Yoshihiro Kando, Osaka (JP); Akira Honjo, Osaka (JP)

Correspondence Address: FOLEY AND LARDNER, SUITE 500, 3000 K STREET NW, WASHINGTON, DC, 20007, US

(21) Appl. No.: 10/433,907

(22) PCT Filed: Jun. 20, 2001
(86) PCT No.: PCT/JP01/05268

(51) Int. Cl. C08K 5/10

(52) U.S. Cl. 524/315

(57) ABSTRACT

The present invention provides an oligomer inhibitor for polyester fiber that fundamentally solves the troubles caused from oligomer in dyeing process of polyester fiber or polyester blend fiber, a combination of polyester fiber and other fibers, without adverse effect on the dyeability of fiber.

The oligomer inhibitor of the present invention comprises one or more of ester compounds selected from the group consisting of the ester compounds of a propylene oxide adduct of a polyhydric alcohol and alkyl or alkenyl fatty acid, and the ester compounds produced in ester exchange reaction of a propylene oxide adduct of a polyhydric alcohol and “animal or vegetable oils and fats containing alkyl and/or alkenyl fatty acid”.

### TECHNICAL FIELD

The present invention relates to the oligomer inhibitor for polyester fiber that solves the troubles caused from polyester oligomer often generated in and after dyeing process of the textiles of polyester fiber and polyester blend fiber, i.e., a combination of polyester fiber and other fibers.

### TECHNICAL BACKGROUND

Polyester fiber is usually dyed at a high temperature of 100 to 150° C. being immersed in a dyebath containing disperse dye.

Polyester fiber usually contains 1 to 5% of polyester oligomer (hereinafter mentioned as “oligomer”), i.e., a byproduct in polyester fiber production, most of which is cyclic ethylene terephthalate.

Such oligomer migrates from the inside of polyester fiber out on the surface of polyester fiber or into dye liquor during dyeing operation of polyester fiber and sticks on polyester fiber surface in subsequent cooling process to cause various troubles.

In cheese dyeing operation, several troubles are found, such as whitening of inner yarn layer caused from the deposition of oligomer as the result of the filtration of dye liquor with polyester yarn, subdued shade of dyed yarn and difference in shade between inner and outer layer of dyed yarn. Oligomer deposition on the inside of dyeing vessels is known as the cause of reduced function of dyeing machines. And oligomer deposited on dyed yarn causes troubles in weaving operation, such as disturbed yarn release from packages, yarn breakage and the troubles due to snow deposit on guide rolls or air nozzles.

The above-mentioned troubles are also found frequently in the dyeing and subsequent processes of polyester blend textiles, which are the combinations of polyester fiber and other fibers.

The conventional and generally adopted oligomer-eliminating processes for solving such troubles caused from oligomer are scouring of polyester fiber before dyeing, mechanical removing of oligomer with hot water and removing oligomer with a dispersant in reduction clearing of dyed textiles. However, eliminating oligomer with dispersing operation did not work well because most of the oligomer migrated out of fiber inside have cyclic molecular structure as mentioned above.

Japanese Patent Application Laid Open Sho-57-89683 discloses a method wherein an ethylene oxide adduct of a polyester of a trihydric or higher alcohol and a saturated or unsaturated hydroxy fatty acid is added to a dyebath for inhibiting migrated-out oligomer from sticking onto fiber. But the method was not effective enough for solving the above-mentioned troubles.

There is another known method in which polyester fiber is dyed in alkali dyeing for the purpose of hydrolyzing polyester oligomer and solving the above-mentioned troubles caused from oligomer. However, dyes applicable to alkali dyeing are more expensive than acid dyes and the color variants are limited because of limited number of applicable dyes.

The present invention has been completed to solve the above-mentioned problems in the conventional technology. The purpose of the invention is to provide an oligomer inhibitor for polyester fiber that meets both of the requirements, “fundamental solution of troubles caused from oligomer” and “no adverse effect on dyed textiles”, in the dyeing operation of polyester fiber and polyester blend fiber, which is a combination of polyester fiber and other fibers.

### DISCLOSURE OF INVENTION

The inventors of the present invention had been studied for preventing fundamentally the migration of oligomer from polyester fiber and polyester blend fiber, a combination of polyester fiber and other fibers, in dyeing process, and finally found that adding a proper ester compound to dyebath can attain the target. The finding is the base of the present invention.

The oligomer inhibitor for polyester fiber (referred simply as “an oligomer inhibitor” in this description) of the present invention is characterized by its composition containing one or more of the ester compounds selected from the group consisting of ester compounds of a propylene oxide adduct of polyhydric alcohol and “an alkyl or alkenyl fatty acid”, and ester compounds produced in ester exchange reaction of a propylene oxide adduct of polyhydric alcohol and animal or vegetable fat and oil containing “an alkyl or alkenyl fatty acid”.

The above-mentioned troubles caused from oligomer can be solved fundamentally by adding the oligomer inhibitor into a dyebath to effectively inhibit oligomer migration out of polyester fiber.

The preferable mole number of propylene oxide added to one mole of polyhydric alcohol for forming propylene oxide adduct is 1 to 30.

And the preferable polyhydric alcohol is glycerin and the preferable carbon number of “an alkyl or alkenyl fatty acid” is 8 to 22.

For the dyeing processes wherein a lot of oligomer migrates out, such as beam dyeing, high-temperature dyeing at 140° C. or more, or dyeing of dye-affinity polyester fiber, it is especially preferable to add a mixture of the oligomer inhibitor of the present invention and “polyester-polyether block copolymer produced from one or more of terephthalic acid and isophthalic acid, lower alkylene glycol, and one or more of polyalkylene glycol and polyalkylene glycol monoether”, being blended in 99-50:1-50 weight ratio into dyebath.

### BEST MODE FOR CARRYING OUT THE INVENTION

The following description shows an example of the best mode of embodiment of the present invention, though the present invention is not restricted within the scope of such embodiment.

The oligomer inhibitor of the present invention contains one or more of ester compounds selected from the group consisting of ester compounds of a propylene oxide adduct of polyhydric alcohol and “alkyl or alkenyl fatty acid” and ester compounds produced in ester exchange reaction of a propylene oxide adduct of polyhydric alcohol and animal or vegetable oils and fats containing “alkyl or alkenyl fatty acid”.

The ester compounds of a propylene oxide adduct of polyhydric alcohol and “alkyl or alkenyl fatty acid” and the ester compounds produced in the ester exchange reaction of a propylene oxide adduct of polyhydric alcohol and animal or vegetable oils and fats containing “alkyl or alkenyl fatty acid” can be produced in known esterification processes. For example, a preferable ester compound can be produced by drawing polyalkylene glycol, which is a propylene oxide adduct of glycerin, as the above-mentioned propylene oxide adduct of polyhydric alcohol, and alkyl fatty acid as the above-mentioned “alkyl or alkenyl fatty acid” in a 1-liter reactor equipped with a thermometer, a reflux condenser and an agitator and by reacting them under inert gas flow at 160-250° C.

Preferable propylene oxide (hereinafter referred as “PO”) adducts of polyhydric alcohol are PO adducts of dimethylol propane, PO adducts of pentaerythritol, PO adducts of sorbitol, PO adducts of sorbitan and PO adducts of glycerin. And PO adducts of glycerin, which is produced by adding propylene oxide to glycerin, is more preferable.

Ethylene oxide (hereinafter referred as “EO”) adducts are not effective for inhibiting the migration of oligomer (hereinafter referred as “oligomer inhibiting effect” in this description), because they are excessively water soluble for their high HLB values and thus they have less affinity to polyester than PO adducts.

The preferable mole number of PO added to the above-mentioned PO adducts of polyhydric alcohols is 1-30 moles per 1 mole of polyhydric alcohol. PO adducts containing more than 30 moles of PO per 1 mole of alcohol adversely affect on the dispersion of dyes in dyebath and disturb expected dyeing of fiber.

The “alkyl or alkenyl fatty acid” in this description is alkyl fatty acid or alkenyl fatty acid, of which examples are caprylic acid, lauric acid, myristic acid, palmitic acid, oleic acid and behenic acid. Above all, “alkyl or alkenyl fatty acid” having 8 to 22 carbon atoms is preferable, and alkyl fatty acid having 10 to 18 carbon atoms is more preferable.

The above-mentioned ester compounds produced in the reaction of PO adducts of polyhydric alcohol and “alkyl or alkenyl fatty acids” are monoester compounds, diester compounds and triester compound. Triester compounds are more preferable because they have higher affinity to polyester fiber than monoester and diester compounds and have much superior oligomer inhibiting effect.

Emulsifiers, which are usually represented by nonionic emulsifiers, are added to dyebath for dispersing dyes in water. And the preferable weight ratio of the oligomer inhibitor of the present invention to such nonionic emulsifiers is 10-90:90-10. Less than 10 weight percent of the oligomer inhibitor of the present invention cannot attain sufficient oligomer inhibiting effect, while more than 90 weight percent of the oligomer inhibitor cannot attain expected dyeing level of textiles.

For the dyeing processes wherein a lot of oligomer migrates out, such as beam dyeing, high-temperature dyeing at 140° C. or more, or dyeing of dye-affinity polyester fiber, it is especially preferable to add a mixture of the oligomer inhibitor of the present invention and “polyester-polyether block copolymer produced from one or more of terephthalic acid and isophthalic acid, lower alkylene glycol, and one or more of polyalkylene glycol and polyalkylene glycol monoether”, being blended in 99-50:1-50 weight ratio into dyebath.

“One or more of terephthalic acid and isophthalic acid” mentioned in “polyester-polyether block copolymer produced from one or more of terephthalic acid and isophthalic acid, lower alkylene glycol, and one or more of polyalkylene glycol and polyalkylene glycol monoether” is one or more of repeating constitutional units derived from terephthalic acid or isophthalic acid. And “polyalkylene glycol” is a repeating constitutional unit derived from polyalkylene glycol. Furthermore “one or more of polyalkylene glycols and polyalkylene glycol monoethers” is one or more of repeating constitutional units derived from polyalkylene glycols and polyalkylene glycol monoethers.

“Polyester-polyether block copolymer produced from one or more of terephthalic acid and isophthalic acid, lower alkylene glycol, and one ore more of polyalkylene glycol and polyalkylene glycol monoether” can be produced in a known esterification process. For example, the copolymer can be produced by drawing terephthalic acid, lower alkylene glycol and polyalkylene glycol in a 1-liter reactor equipped with a thermometer, a reflux condenser and an agitator and by reacting them under inert gas flow at 160-250° C.

The examples of lower alkylene glycol are ethylene glycol, propylene glycol, tetramethylene glycol and pentamethylene glycol.

The preferable polyalkylene glycols are those having 400-12000 average molecular weight, more preferably 600-6000, such as polyethylene glycols, polyethylene glycol-polypropylene glycol copolymers and polypropylene glycols. The preferable monoethers of polyalkylene glycol are monomehtyl ethers such as polyethylene glycol and polypropylene glycol, monoehtyl ethers and monophenyl ethers. Among those, monoethers of polyethylene glycol are more preferable for improving the dispersion of dyes in dyebath.

The preferable dyeing processes for polyester fiber are those in which polyesterfiberisimmersedindyebath. Andthedyeingtechniquesarecheese dyeing, beam dyeing and high-temperature dying at 140° C. or higher. Any method that can attain the purpose of the present invention can be adopted with no restriction.

### EXAMPLES

The present invention is further described with the following examples and comparative examples though the present invention is not restricted within the scope of those examples.

Polyester fiber was dyed in cheese dyeing, aprocess consisting of dyeing, reduction cleaning, oiling and drying.

The dyeing parameters and testing procedure of migrated oligomer adopted in the examples are as follows.

A. Dyeing Parameters

Dyeing

Machine: Cheese Dyeing Machine HUHT-250-350 (Nichihan Seisakusho)

Yarn sample: spun yarn, polyester 100%, 60/3

Dyes: AP Black EZ300 (5.5% owf), MP Yellow 3 GSL (0.7% owf)

Oligomer inhibitor: 2 g/liter

Dispersant for dyes: MARVELIN B-10 (Matsumoto Yushi-Seiyaku Co., Ltd.), 0.5 g/liter

pH of dye liquor: 5 (controlled with acetic acid and sodium acetate)

Yarn to dye liquor ratio: 1 to 12

Temperature and time for dyeing: 130° C. and 50 minutes

Reduction Cleaning

Reducing agent: hydrosulfite, 2.0 g/liter

Sodium hydroxide: 2.0 g/liter

Dispersant: MARVELIN S-1000 (Matsumoto Yushi-Seiyaku Co., Ltd.), 1.0 g/liter

Temperature and time for scouring: 75° C. and 20 minutes

Oiling

Oil: A lubricant for dyed cheese (Matsumoto Yushi-Seiyaku Co., Ltd.), 9% owf

Temperature and time for oiling: 80° C. and 20 minutes

Drying

Machine: Cheese Dyeing Machine HUHT-250-350 (Nichihan Seisakusho)

Dehydration time: 5 minutes

Temperature and time for drying: 100° C. and 1 hour

The “g/liter” mentioned above means grams of agents per 1 liter of water.

The formulae of the oligomer inhibitors tested in the dyeing test mentioned above are as follows.

### Example 1

Trilaurate of PO (3) glycerin adduct: 20 parts

Nonionic ether surfactant having 9.7 HLB: 20 parts

Water: 60 parts

### Example 2

Monolaurate of PO (3) glycerin adduct: 20 parts

Nonionic ether surfactant having 9.7 HLB: 20 parts

Water: 60 parts

### Example 3

Trilaurate of PO (10) glycerin adduct: 20 parts

Nonionic ether surfactant having 9.7 HLB: 20 parts

Water: 60 parts

### Example 4

Triester of coco fatty acid of PO (6) glycerin adduct: 20 parts

Nonionic ether surfactant having 9.7 HLB: 20 parts

Water: 60 parts

### Example 5

Triester of coco fatty acid of PO (6) glycerin adduct: 20 parts

Nonionic ether surfactant having 9.7 HLB: 16 parts

Polyester-polyether block copolymer: 7 parts

Water: 60 parts

### Comparative Example 1

Polyoxyethylene adduct of sorbitane monolaurate: 40 parts

Water: 60 parts

### Comparative Example 2

EO/PO (50:50) polyether monostearate: 28 parts

Monoester of coco fatty acid and polyoxyethylene: 12 parts

Water: 60 parts

### Comparative Example 3

Nonionic ether surfactant having 9.7 HLB: 40 parts

Water: 60 parts

### Comparative Example 4

EO (30) stearyl amino ether adduct: 40 parts

Water: 60 parts

### Comparative Example 5

EO (18) styrenated phenol adduct: 40 parts

Water: 60 parts

The nonionic ether surfactant having 9.7 HLB value mentioned above is ACTINOL HC-18 produced by Matsumoto Yushi-Seiyaku Co., Ltd.

The polyester-polyether block copolymer in Example 5 is ES-200, a copolymer of terephthalic acid, ethylene glycol and polyethylene glycol, produced by Takamatsu Oil & Fat Co., Ltd.

The PO (x) glycerin adducts are those in which x moles of PO are added to 1 mole of glycerin.

The EO (30) stearyl amino ether adducts are those in which 30 moles of EO are added to 1 mole of stearyl amino ether. And the EO (18) styrene phenol adducts are those in which 18 moles of EO are added to 1 mole of styrene phenol.

B. Testing Procedure for Migrated Oligomer

Percentage of Oligomer and Oil

The cheeses of the yarn samples (spun yarn, polyester 100%, 60/3) dyed with the above-mentioned parameters were separated into inner, middle and outer yarn layers. Then each yarn sample was extracted with Soxhlet extraction apparatus and n-hexane for 2 hours. Then the solvent was removed from the extracts and the remained extracts were dissolved with n-hexane of normal temperature to dissolve oil on yarn and to separate oligomer, which was insoluble in n-hexane. The amount of the separated oligomer was calculated into the percentage to each yarn sample weight. On the other hand, the quantity of the oil dissolved in n-hexane was also determined and calculated into the percentage to each yarn sample weight.

Dyeability of Yarn

The color difference of middle and outer layer of dyed yarn samples was tested with a Spectrocolorimeter CLR-7100F (Shimazu Seisakusho) settling the color of inner layer as the standard.

Lubricity

The lubricity of dyed yarn samples was tested with Knitting tester KS-2 (Sugihara Testing Machine Co., Ltd.).

The data from the oligomer migration test is shown in Table 1.

TABLE 1

| | | | | Color | | | | |
|---|---|---|---|---|---|---|---|---|
| | Yarn | Oligo- | Oil | differ- | Lubricity (g) | | | |
| Oligomer inhibitor | layer | mer (%) | (%) | ence (ΔE) | 100 m | 10 m | 1 m | ΔT |
| None | inner | 0.35 | 2.85 | 0.00 | 250 | 122 | 119 | 131 |
| | medium | 0.28 | 2.94 | 0.89 | 252 | 115 | 110 | 142 |
| | outer | 0.23 | 2.79 | 0.78 | 258 | 117 | 110 | 138 |
| Example 1 | inner | 0.03 | 2.47 | 0.00 | 236 | 118 | 115 | 121 |
| | medium | 0.05 | 2.56 | 0.99 | 238 | 119 | 112 | 126 |
| | outer | 0.03 | 2.68 | 0.67 | 232 | 116 | 119 | 113 |
| Example 2 | inner | 0.12 | 2.71 | 0.00 | 231 | 117 | 107 | 124 |
| | medium | 0.14 | 2.59 | 0.52 | 235 | 115 | 109 | 126 |
| | outer | 0.17 | 2.49 | 0.78 | 234 | 114 | 109 | 125 |
| Example 3 | inner | 0.04 | 2.47 | 0.00 | 239 | 121 | 113 | 126 |
| | medium | 0.04 | 2.52 | 0.78 | 230 | 115 | 110 | 120 |
| | outer | 0.05 | 2.30 | 0.80 | 233 | 118 | 112 | 121 |
| Example 4 | inner | 0.05 | 2.50 | 0.00 | 240 | 119 | 114 | 126 |
| | medium | 0.03 | 2.51 | 0.68 | 235 | 116 | 112 | 123 |
| | outer | 0.05 | 2.48 | 0.58 | 234 | 117 | 112 | 122 |
| Example 5 | inner | 0.03 | 2.49 | 0.00 | 232 | 118 | 109 | 114 |
| | medium | 0.03 | 2.49 | 0.60 | 237 | 120 | 101 | 117 |
| | outer | 0.02 | 2.57 | 0.69 | 244 | 119 | 115 | 125 |
| Comparative | inner | 0.26 | 2.67 | 0.00 | 242 | 120 | 118 | 124 |
| example 1 | medium | 0.34 | 2.68 | 0.79 | 239 | 117 | 112 | 127 |
| | outer | 0.22 | 2.79 | 0.91 | 241 | 119 | 114 | 127 |
| Comparative | inner | 0.31 | 2.64 | 0.00 | 241 | 117 | 109 | 132 |
| example 2 | medium | 0.30 | 2.81 | 0.99 | 244 | 118 | 107 | 137 |
| | outer | 0.23 | 2.89 | 1.09 | 240 | 121 | 106 | 134 |
| Comparative | inner | 0.24 | 2.85 | 0.00 | 240 | 122 | 119 | 121 |
| example 3 | medium | 0.21 | 2.68 | 0.89 | 242 | 115 | 110 | 132 |
| | outer | 0.19 | 2.71 | 0.99 | 248 | 117 | 110 | 138 |
| Comparative | inner | 0.31 | 2.48 | 0.00 | 247 | 119 | 109 | 128 |
| example 4 | medium | 0.30 | 2.39 | 1.17 | 249 | 120 | 107 | 132 |
| | outer | 0.23 | 2.40 | 0.99 | 245 | 123 | 106 | 129 |
| Comparative | inner | 0.27 | 2.67 | 0.00 | 243 | 119 | 107 | 136 |
| example 5 | medium | 0.29 | 2.73 | 1.01 | 240 | 119 | 106 | 134 |
| | outer | 0.30 | 2.87 | 1.17 | 246 | 120 | 108 | 138 |

As shown in Table 1, little oligomermiigrated out of fiber in the dyebaths in which the oligomer inhibitors of Examples were added. And the little difference in the color between the inner and outer layers of dyed polyester yarn samples and their satisfactory lubricity proved that the oligomer inhibitors of Examples did not to give adverse effect to the dyeability of polyester yarn samples.

Possibility of Industrial Use

The present invention provides an oligomer inhibitor for polyester fiber that meets both of the requirements, “fundamental solution of troubles caused from oligomer” and “no adverse effect on dyed textiles”, in the dyeing operation of polyester fiber and polyester blend fiber, i.e., a combination of polyester fiber and other fibers.

In addition, the present invention provides an oligomer inhibitor that does not increase the steps of dyeing process as the oligomer inhibitor is effective only with the addition to dyebath, in other words, it can be applied to dyeing process of fibers with easy handling and without special processing steps for eliminating oligomer.

1. An oligomer inhibitor for polyester fiber comprising one or more of ester compounds selected from the group consisting of: an ester compound of a propylene oxide adduct of polyhydric alcohol and an “alkyl or alkenyl fatty acid”; and an ester compound produced in ester exchange reaction of a propylene oxide adduct of polyhydric alcohol with an animal or vegetable oil and fat containing an “alkyl or alkenyl fatty acid”.

2. An oligomer inhibitor for polyester fiber defined in claim 1 wherein the propylene oxide is added from 1 to 30 moles per 1 mole of polyhydric alcohol in the propylene oxide adduct of polyhydric alcohol.

3. An oligomer inhibitor for polyester fiber defined in claim 1 or 2 wherein the polyhydric alcohol is a trihydric alcohol, and the ester compound is a triester.

4. An oligomer inhibitor for polyester fiber defined in claim 3 wherein the trihydric alcohol is glycerin.

5. An oligomer inhibitor for polyester fiber defined in any one of the claims 1 to 4 wherein the “alkyl or alkenyl fatty acid” contains from 8 to 22 carbon atoms.

6. An oligomer inhibitor for polyester fiber, which comprises an oligomer inhibitor defined in any one of claims 1 to 5, and a “polyester-polyether block copolymer produced from: at least one of telephthalic acid and isophthalic acid; a lower alkylene glycol; and at least one of polyalkylene glycol and polyalkylene glycol monoether”, being blended in 99-50:1-50 weight ratio.
